(19) United States
(12) Patent Application Publication
(10) Pub. No.: US 2006/0221881 A1
(43) Pub. Date: Oct. 5, 2006

(54) Information processing apparatus and power source control method

(75) Inventor: Toshikazu Morisawa, Tokorozawa-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/375,066

(22) Filed: Mar. 15, 2006

(30) Foreign Application Priority Data
Mar. 15, 2005 (JP) 2005-073914

(51) Int. Cl. G08C 17/00

(52) U.S. Cl. 370/311

(57) ABSTRACT

According to one embodiment, an information processing apparatus includes: a wireless communication part which performs wireless communication using a wireless signal of a predetermined frequency band; a detection part which detects intensity of the wireless signal; and a power source control part which supplies a power source to the detection part in a first state of the information processing apparatus, the power source control part, when a value of intensity of the wireless signal detected by the detection part is larger than a predetermined threshold value, which shifts a state of information processing apparatus from the first state to a second state in which the power source is supplied to at least the detection part and the wireless communication part.

### CROSS-REFERENCE TO RELATED APPLICATIONS

This application is based upon and claims the benefit of priority from Japanese Patent Application No. 2005-073914, filed Mar. 15, 2005, the entire contents of which are incorporated herein by reference.

### BACKGROUND

1. Field

One embodiment of the invention relates to an information processing apparatus such as a personal computer, and particularly to an information processing apparatus capable of conducting wireless communication.

2. Description of the Related Art

In recent years, a notebook personal computer equipped with a wireless communication device for meeting IEEE802.11 standards (wireless LAN) has been developed. This kind of computer can make connection to an external network such as the Internet wirelessly when it is inside a public wireless LAN service area.

Also, a computer having a function of searching a nearby public wireless LAN service area has been developed recently. This search function is normally implemented by a wireless communication device and software for controlling the wireless communication device. As a result of this, the search function can be used in a state in which a power source of the computer has been turned on, but cannot be used in a state in which the power source of the computer has been turned off. Also, a power source control method of an intermittent power-on type in a mobile station in which a mobile station automatically changes to a power-on state in synchronization with timing of a beacon signal sent from a base station and a certain period subsequent to that is set at a period capable of receiving data sent from the base station is described in, for example, Japanese Patent Application Publication (KOKAI) No. 9-162798.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing one example of a state in which a display unit of a computer is opened with respect to a body;

FIG. 2 is an exemplary diagram showing one example of a hardware configuration of the computer;

FIG. 3 is an exemplary diagram describing one example of a configuration of a wireless LAN device and control of electric power supply to the wireless LAN device;

FIG. 3 is an exemplary plan view of a module-housing section according to a first embodiment of the invention;

FIG. 4 is an exemplary diagram describing one example of a relation between a power source state of the computer and a power source state of the wireless LAN device;

FIG. 5 is one example of an exemplary flowchart describing a system action of the computer in the case that the computer enters the inside of a wireless LAN service area from the outside of the wireless LAN service area;

FIG. 6 is one example of an exemplary flowchart describing a system action after a power source state of the computer shifts from a suspend state or an off state to an on state;

FIG. 7 is one example of an exemplary flowchart describing a system action after the power source state of the computer shifts to the suspend state;

FIG. 8 is an exemplary diagram showing one example of a screen for setting a wake-up function to the on state in the case that the computer enters the inside of a wireless LAN service area from the outside of the wireless LAN service area;

FIG. 9 is an exemplary diagram showing a modified example of control of electric power supply to the wireless LAN device described by using FIG. 3;

FIG. 10 is an exemplary diagram showing one example of a screen for setting a control function of electric power supply to components inside the wireless LAN device after waking up to an on state in the case that a computer enters the inside of a wireless LAN service area from the outside of the wireless LAN service area;

FIG. 11 is an exemplary diagram showing one example of a hardware configuration of a computer according to a second embodiment;

FIG. 12 is an exemplary diagram describing one example of control of electric power supply to a wireless LAN device and a configuration of the wireless LAN device in the second embodiment; and

FIG. 13 is an exemplary diagram showing a modified example of control of electric power supply to the wireless LAN device described by using FIG. 12.

### DETAILED DESCRIPTION

Various embodiments according to the invention will be described herein after with reference to the accompanying drawings. In general, according to one embodiment of the invention, an information processing apparatus capable of conducting wireless communication with an external device, includes: a wireless communication part which conducts the wireless communication using a wireless signal of a predetermined frequency band; a detection part which detects intensity of the wireless signal; and a power source control part which shifts the information processing apparatus from a suspend state to a power-on state in which a power source is supplied to at least the wireless communication part when a power source is supplied to the detection part at the time of the suspend state of the information processing apparatus and a value of intensity of the wireless signal detected by the detection part is larger than a predetermined threshold value.

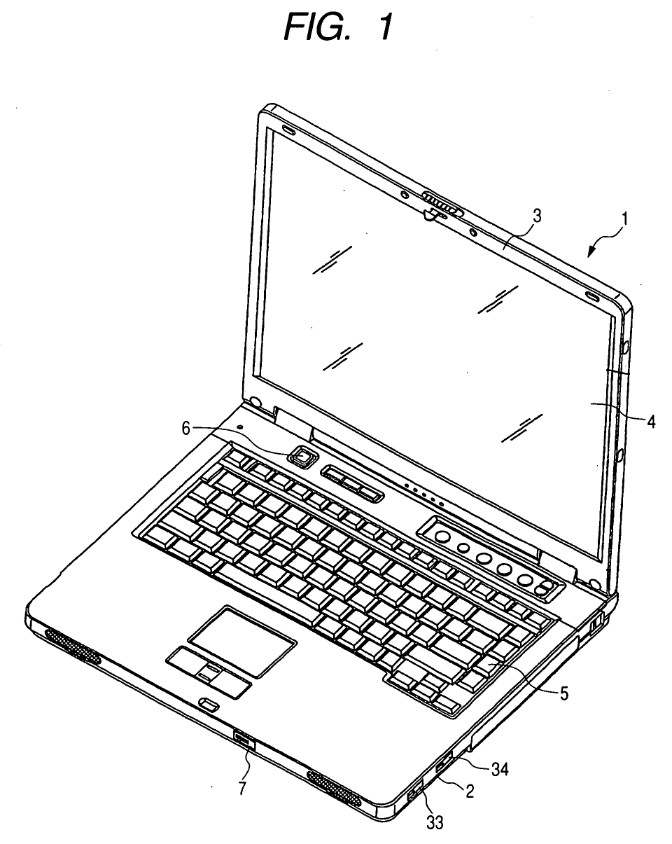

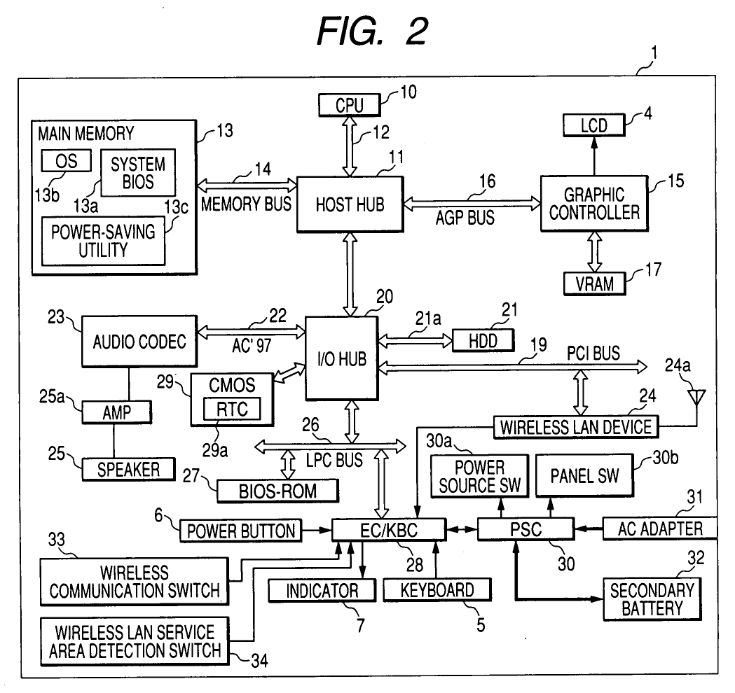

Referring to FIGS. 1 and 2, one example of a configuration of an information processing apparatus according to one embodiment of the invention will be described. The information processing apparatus is a portable information processing apparatus having a function of conducting wireless communication such as a wireless LAN, and is implemented as a notebook personal computer (hereinafter called a computer) 1.

FIG. 1 is an exemplary perspective view showing one example of a state in which a display unit 3 of the notebook personal computer (hereinafter called a computer) 1 is opened with respect to a body 2.

The computer 1 includes the body 2 and the display unit 3. A display having an LCD (Liquid Crystal Display) 4 is incorporated into the display unit 3, and the LCD 4 is located in approximately the center of the display unit 3.

The display unit 3 is supported on the body 2, and is rotatably mounted with respect to the body 2 between an opened position in which an upper surface of the body 2 is exposed and a closed position in which the upper surface of the body 2 is covered. The body 2 has an approximately box shape, and a keyboard unit 5, a power button 6 for turning on and off a power source of the computer 1, etc., are arranged on the upper surface of the body 2. The power button 6 is depressed and operated in the case of starting to use the computer 1.

Also, the body 2 is provided with a wireless communication switch 33, a wireless LAN service area detection switch 34, an indicator 7, etc.

The wireless communication switch 33, the wireless LAN service area detection switch 34 and the indicator 7 are arranged in, for example, the side or the front of the body 2 exposed to the outside in a state in which the display unit 3 is in the closed position so that a user can operate even in a state in which the display unit 3 is in the closed position with respect to the body 2.

Functions of the wireless communication switch 33, the wireless LAN service area detection switch 34 and the indicator 7 will be described later in detail.

Further, the body 2 is equipped with, for example, a wireless LAN device 24 as a wireless communication part for conducting wireless communication with a wireless service area such as a public wireless LAN service area provided by a wireless LAN access point (base station) Next, a configuration of the computer 1 will be described.

FIG. 2 is an exemplary diagram showing one example of a hardware configuration of the computer 1.

A CPU 10, main memory 13, a graphics controller 15 and an I/O (Input/Output) hub 20 are connected to a host hub (first bridge circuit) 11.

The host hub 11 is connected to the CPU 10 through a system bus 12. A memory controller for controlling access to the main memory 13 is built into the host hub 11.

The CPU 10 is a main processor for controlling a system of the computer 1. The CPU 10 executes an operating system (OS) 13b, an application program, a wireless LAN device power-saving utility program 13c, etc., loaded from an HDD 21 which is an external storage device to the main memory 13 through a memory bus 14. The wireless LAN device power-saving utility 13c will be described later.

Also, the CPU 10 executes a System BIOS (Basic Input Output System) 13a loaded from BIOS-ROM 27 to the main memory 13.

The graphics controller 15 connected to the host hub 11 through an AGP (Accelerated Graphics Port) bus 16 outputs a digital display signal to the LCD 4. Video memory (VRAM) 17 is connected to the graphics controller 15, and the graphics controller 15 displays data drawn in the video memory 17 on the LCD 4 by an OS/application program.

The I/O hub (second bridge circuit) 20 connected to the host hub 11 through a dedicated bus such as a hub interface controls each of the devices connected to an LPC (Low pin count) bus 26 and each of the devices connected to a PCI (Peripheral Component Interconnect) bus 19.

A serial ATA (AT Attachment) controller for controlling an HDD 117 is built into the I/O hub 20. The I/O hub 20 is connected to the HDD 21 which is an external storage device and supports serial ATA standards through a serial ATA bus 21a for supporting serial ATA standards.

The HDD (magnetic disk device) 21 is a magnetic disk device. The operating system (OS) 13b, an application program, the wireless LAN device power-saving utility program 13c, and data, etc., generated by using the application are stored in the HDD 21.

Also, an audio codec 23 and a CMOS 29 are connected to the I/O hub 20.

The audio codec 23 is connected to the I/O hub 20 through an AC (Audio Codec) 97 (22). The audio codec 23 is a kind of codec for input and output of sound. The audio codec 23 has a codec part, etc., of sound inputted and outputted.

An amplifier (AMP) 25a is connected to the audio codec 23. The AMP 25a amplifies a sound signal generated by the audio codec 23. The sound signal amplified by the AMP 25a is sent out to a speaker and the speaker outputs sound waves of an audio frequency band.

An RTC (Real Time Clock) 29a is built into the CMOS (complementary metal-oxide semiconductor) 29. The RTC 29a is a module for counting the time and date, and operates using a power source supplied from, for example, a built-in battery even at the time of a system power-off state.

Also, set contents, etc., specified by a Setup screen of BIOS are stored in the CMOS 29.

The wireless LAN device 24 is connected to the PCI bus 19.

The wireless LAN device 24 is a wireless communication device for meeting, for example, IEEE802.11 standards, and conducts wireless communication with an access point of a wireless LAN service area using a frequency band of 5.2 GHz or 2.4 GHz, for example, an ISM (Industrial Scientific and Medical) band. Also, the wireless LAN device 24 is connected to an EC/KBC 28.

The BIOS-ROM 27 and the embedded controller/keyboard controller IC (EC/KBC) 28 are connected to the LPC bus 26.

The BIOS-ROM 27 is a storage medium for storing the System BIOS 13a, etc. The storage medium used as the BIOS-ROM 27 is a storage medium such as a flash memory in which a program can be rewritten.

The System BIOS 13a is a program for systemizing a function execution routine for accessing various hardware. The System BIOS 13a includes an IRT routine for performing a test and initialization of various devices at the time of power-on to a system and a group of drivers for controlling various hardware.

The embedded controller/keyboard controller IC (EC/KBC) 28 is a one-chip microcomputer into which an embedded controller for performing power management, etc., and a keyboard controller for controlling the keyboard (KB) unit 5 are integrated.

The keyboard 5, the power button 6, the indicator 7, a PSC (Power Supply Controller) 30, the wireless communication switch (WCS) 33, the wireless LAN service area detection switch (SW) 34 and the indicator 7 are connected to the EC/KBC 28.

The EC/KBC 28 has a power source status notification function, etc., and a power source sequence control function of controlling on-off, etc., of a system power source in cooperation with the PSC 30. Electric power is supplied to the EC/KBC 28 even when a power source state of the computer 1 is in any state.

The power source status notification function is a function of monitoring occurrence of a wake-up event which becomes a start factor of a resume processing routine in cooperation with the PSC 30 and notifying the System BIOS 13a that the event occurs using a system management, interrupt SMI (System Management Interrupt) at the time of the occurrence of the wake-up event.

The wake-up event includes on of a power source switch 30a in response to a depression operation of the power button 6, on of a panel switch 30b in response to an operation for changing the display unit 3 from a closed state to an opened state with respect to the body 2 and so on.

The EC/KBC 28 has an I/O port for communicating with the System BIOS 13a. The System BIOS 13a makes settings of kinds of notification events and monitoring, reading of statuses indicating occurrence events by performing reading/writing with respect to a configuration register disposed in the EC/KBC 28 through the I/O port. Communication between the EC/KBC 28 and the PSC 30 is conducted through an I2C bus.

The PSC 30 which is a power source control part supplies electric power supplied from an AC adapter 31 or a secondary battery 32 to each of the modules inside the computer 1. The secondary battery 32 is replaceably disposed. When a power source is supplied from the AC adapter 31 to the computer 1, electric power supplied from the AC adapter 31 is accumulated in the secondary battery 32 through the PSC 30.

When a user operates the power button 6, the EC/KBC 28 detects that the power button 6 is operated. When the EC/KBC 28 detects that the power button 6 is operated, for example, the PSC 30 is notified to start power source supply to a system of the computer 1. The PSC 30 performs control so as to start the power source supply from the AC adapter 31 or the secondary battery 32 to the system of the computer 1 based on the notification from the EC/KBC 28.

Also, the EC/KBC 28 has functions of controlling the wireless communication switch (WCS) 33, the wireless LAN service area detection switch (WSDS) 34 and the indicator 7.

The wireless communication switch 33 is a switch operated for turning on and off a function of the wireless LAN device 24 mounted in the body 2. The wireless communication switch 33 is a two-state switch having two states of an on state of instructing on of the function of the wireless LAN device 24 and an off state of instructing off of the function of the wireless LAN device 24.

In the case that the wireless communication switch 33 is set in an on state by a user when a system state of the computer 1 is in an on state, the function of the wireless LAN device 24 is turned on. As one of methods for turning on the function of the wireless LAN device 24, a method for supplying electric power to the wireless LAN device 24 is contemplated.

On the other hand, in the case that the wireless communication switch 33 is set in an off state by a user when a system state of the computer 1 is in an on state, the function of the wireless LAN device 24 is turned off. As one of methods for turning off the function of the wireless LAN device 24, a method for stopping electric power supply to the wireless LAN device 24 is contemplated.

The wireless LAN service area detection switch 34 is an operation switch for instructing execution of a search function of searching a public wireless LAN service area. A user operates the wireless LAN service area detection switch 34 and thereby, on-off of a public wireless LAN service area search function is switched. On-off switching control of the public wireless LAN service area search function will be described later in detail.

The indicator 7 is a display device (display part) for displaying status information indicating wireless communication environment corresponding to the present position of the computer 1 in response to intensity of a wireless signal sent from a wireless LAN service area searched by the search function. The indicator 7 includes a display device such as an LED (Light Emitting Diode).

The status information displayed in the indicator 7 indicates, for example, a level of radio field intensity of a wireless signal received by the wireless LAN device 24.

Description will be made later in detail, but the computer 1 has a function of receiving a wireless signal from a wireless LAN access point and displaying radio field intensity of the received wireless signal in the indicator 7 as the status information when a user turns on the wireless LAN service area detection switch 34 during, for example, an off state or a suspend state of the computer 1. Next, a configuration of the wireless LAN device 24 and control of electric power supply to the wireless LAN device 24 will be described.

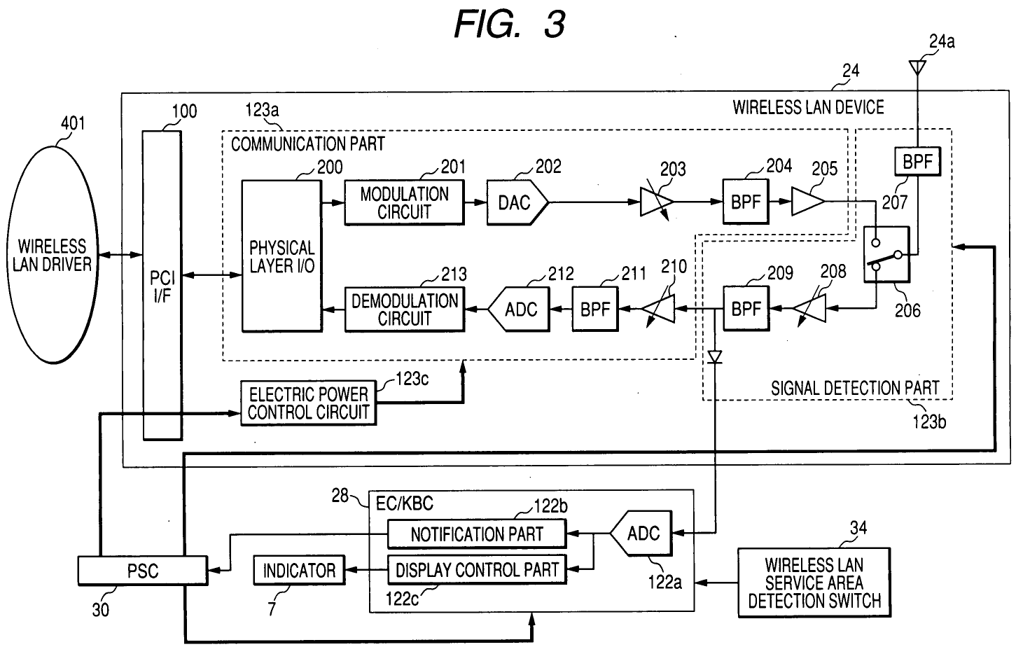

FIG. 3 is an exemplary diagram describing one example of a configuration of the wireless LAN device 24 and control of electric power supply to the wireless LAN device 24.

The wireless LAN device 24 includes a PCI interface 100, a communication part 123a, a signal detection part 123b and an electric power control circuit 123c. The PCI interface 100 is an interface disposed for connecting the wireless LAN device 24 to the PCI bus 19. The electric power control circuit 123c is a circuit for controlling electric power supply to components constituting the wireless LAN device 24.

The communication part 123a is a unit for sending and receiving data using a wireless signal, and includes a physical layer I/O (Input/Output) device 200, a modulation circuit 201, a digital-to-analog converter (DAC) 202, a power amplifier 203, a band-pass filter (BPF) 204, a power amplifier 205, a power amplifier 210, a band-pass filter 211, an analog-to-digital converter (ADC) 212 and a demodulation circuit 213.

The signal detection part 123b is a unit for detecting intensity of a wireless signal sent from an access point, and includes a switch 206, a band-pass filter 207, a power amplifier 208 and a band-pass filter 209.

A configuration of the communication part 123a will be described. The communication part 123a includes a sending part and a receiving part. The sending part for sending data includes the modulation circuit 201, the digital-to-analog converter 202, the power amplifier 203, the band-pass filter 204 and the power amplifier 205. Also, the receiving part for receiving data includes the power amplifier 208, the band-pass filter 209, the power amplifier 210, the band-pass filter 211, the analog-to-digital converter 212 and the demodulation circuit 213. The power amplifier 208 and the band-pass filter 209 included in the receiving part has a detection function of detecting a signal level of a wireless signal received through an antenna 24a. Therefore, the power amplifier 208 and the band-pass filter 209 are shared by the communication part 123a and the signal detection part 123b.

A function of the sending part will be described. For example, data sent out to a wireless LAN access point is inputted to the modulation circuit 201 through the PCI interface 100 and the physical layer I/O device 200 and is modulated. The physical layer I/O device 200 is an interface for connecting the wireless LAN device 24 to a PCI connector connected to the PCI bus 19.

A signal obtained by the modulation circuit 201 is inputted to the digital-to-analog converter (DAC) 202 and digital-to-analog conversion is made. A signal obtained by the digital-to-analog conversion processing by the DAC 202 is inputted to the power amplifier 203 and gain of the signal is controlled. A signal obtained by the gain control processing by the power amplifier 203 is inputted to the band-pass filter (BPF) 204 and a signal of a frequency band of 2.4 GHz is extracted.

A signal obtained by the signal extraction processing by the band-pass filter 204 is inputted to the power amplifier 205 and gain of the signal is controlled. A signal obtained by the gain control by the power amplifier 205 is inputted to the band-pass filter 207 through the switch 206 and a signal of a frequency band of 2.4 GHz is extracted. In the case of sending out a signal, the switch 206 is switched so as to connect the power amplifier 205 and the band-pass filter 207. A signal obtained by the signal extraction processing by the band-pass filter 207 is sent to, for example, a wireless LAN access point through the antenna 24a.

Next, a function of the receiving part will be described. A wireless signal received from a wireless LAN access point through the antenna 24a is inputted to the band-pass filter 207 and the band-pass filter 207 extracts a wireless signal of a frequency band of 2.4 GHz. A wireless signal obtained by the signal extraction processing by the band-pass filter 207 is inputted to the power amplifier 208 through the switch 206.

In the case of receiving a wireless signal, the switch 206 is switched so as to connect the band-pass filter 207 and the power amplifier 208. A wireless signal obtained by gain control by the power amplifier 208 is inputted to the band-pass filter 209 and the band-pass filter 209 extracts a wireless signal of a frequency band of 2.4 GHz. A wireless signal obtained by the signal extraction processing by the band-pass filter 209 is inputted to the power amplifier 210.

A wireless signal obtained by gain control by the power amplifier 210 is inputted to the analog-to-digital converter (ADC) 212 through the band-pass filter 211 and the ADC 212 makes analog-to-digital conversion. A digital signal obtained by the analog-to-digital conversion processing by the ADC 212 is inputted to the demodulation circuit 213 and is demodulated. A signal obtained by the demodulation processing by the demodulation circuit 213 is sent out to the CPU 10 through the physical layer I/O device 200 and the PCI interface 100.

On the other hand, a signal of a band of 2.4 GHz extracted by the band-pass filter 209 is also inputted to the EC/KBC 28 through a rectifier diode.

The EC/KBC 28 includes an analog-to-digital converter (ADC) 122a, a notification part 122b and a display control part 122c. The ADC 122a and the notification part 122b are a portion of a wireless signal detection part used for detecting intensity of a wireless signal.

A signal of a band of 2.4 GHz extracted by the band-pass filter 209 is inputted to the ADC 122a through a rectifier diode. The ADC 122a makes analog-to-digital conversion of the signal extracted by the band-pass filter 209.

A digital signal obtained by the analog-to-digital conversion processing by the ADC 122a is inputted to the display control part 122c.

The display control part 122c evaluates a signal level of the digital signal converted by the ADC 122a. The display control part 122c has a status display function of displaying status information corresponding to intensity (electric field intensity) of the received wireless signal in the indicator 7.

The display control part 122c lights up, for example, the indicator 7 when intensity of the digital signal is larger than a predetermined threshold value. Also, the display control part 122c blinks, for example, the indicator 7 when the digital signal is smaller than or equal to the predetermined threshold value. The display control part 122c can also change a luminescent color of the indicator 7 according to a signal level detected.

The notification part 122b evaluates a signal level of the digital signal converted by the ADC 122a. The notification part 122b sends out a PME (Power Management Event) signal to the PSC 30 according to a signal level corresponding to intensity of the received wireless signal. Timing, etc., at which the PME signal is sent out of the notification part 122b will be described later in detail.

The PSC 30 supplies electric power to the communication part 123a and the signal detection part 123b. The PSC 30 supplies electric power to the communication part 123a through the PCI interface 100 and the electric power control circuit 123c, and supplies electric power to the signal detection part 123b without intervention of the PCI interface 100.

Description will be made later in detail, but the PSC 30 can supply electric power to the communication part 123a through the PCI interface 100 and the electric power control circuit 123c when a power source state of the computer 1 is an on state. The electric power control circuit 123c is controlled by a command sent out of a wireless LAN driver 401 when a power source state of the computer 1 is an on state.

Also, the PSC 30 can supply electric power to the signal detection part 123b without intervention of the PCI interface 100 when a power source state of the computer 1 is an off state, a suspend state or an on state.

In the case that a user operates the wireless LAN service area detection switch 34 so as to turn on a wireless LAN service area detection function when a power source state of the computer 1 is a suspend state or an off state, the EC/KBC 28 detects that the wireless LAN service area detection switch is turned on. The EC/KBC 28 instructs the PSC 30 to supply electric power to the signal detection part 123b in the case of detecting the wireless LAN service area detection switch is turned on. The PSC 30 supplies electric power to the signal detection part 123b based on instructions from the EC/KBC 28.

When the PSC 30 supplies electric power to the signal detection part 123b, states of the EC/KBC 28 and the signal detection part 123b become a state of supplying the electric power. When the electric power is supplied to the EC/KBC 28 and the signal detection part 123b, the wireless LAN service area detection function is turned on and also a status display function of indicating wireless communication environment corresponding to the present position of the computer 1 in the indicator 7 is turned on. One example of a use method of the status display function will be described.

Normally, when a user determines whether or not wireless communication with a public wireless LAN service area can be conducted in the present position of the computer 1 while the computer 1 is carried, for example, it is necessary to perform an operation for changing a display unit from a closed position state to an opened position state and an operation for changing a computer to a power-on state.

When a user operates the wireless LAN service area detection switch 34 so as to turn on a wireless LAN service area detection function, electric power is supplied to the signal detection part 123b even when a power source state of the computer 1 is an off state or a suspend state. Therefore, the user can know wireless communication environment corresponding to the present position of the computer 1 without changing a power source state to an on state by operating the power button 6 disposed in the computer 1.

Also, when a user carries the computer 1, the display unit 3 is in a closed position state with respect to the body 2. The indicator 7 is arranged in a position capable of being seen by the user even when the display unit 3 is in a closed position state with respect to the body 2, so that the user can check status information by seeing the indicator 7 without opening the display unit 3 of the computer 1 with respect to the body 2. Next, a relation between a power source state and a power source state of the wireless LAN device 24 will be described.

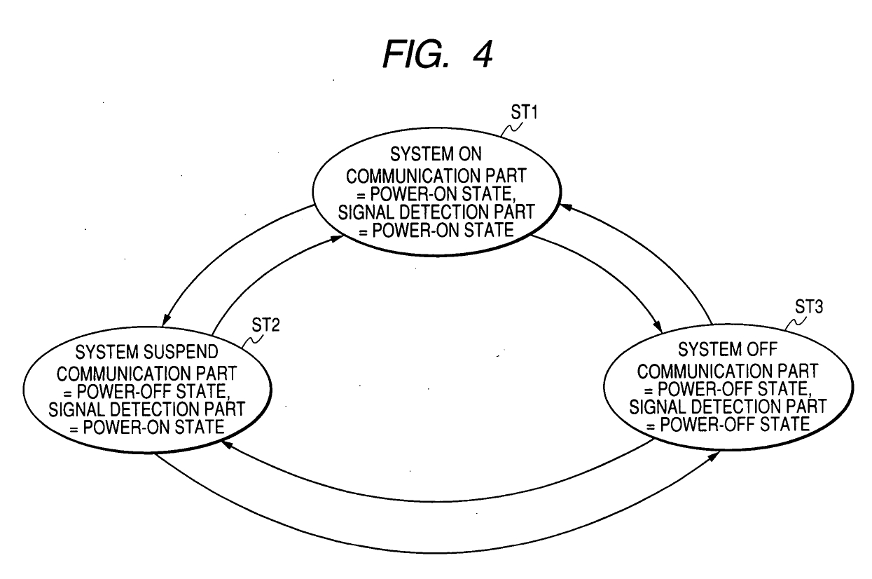

FIG. 4 is an exemplary diagram describing one example of a relation between a power source state of the computer 1 and a power source state of the wireless LAN device 24.

The computer 1 has power source states broadly divided into an on (power-on) state ST1, a suspend state ST2 and an off (power-off) state ST3.

Here, ACPI (Advanced Configuration and Power Interface Specification) specifications which are a power management technique adopted by the computer 1 will be described.

The ACPI specifications are techniques for reducing power consumption of the computer 1 and reducing time taken to return a system state to an action state, etc.

In the ACPI specifications, plural sleep states are defined as system states between an action state and a stop state in addition to the action state and the stop state.

In the ACPI specifications, system states of S0 to S5 are defined. S0 is an action state (a state in which a power source of a system is turned on and software is executing), and S5 is an off state (a state in which execution of software is ended and the power source of the system is not turned on), and S1 to S4 are a state between S0 and S5 (called a sleep state and a state in which an action of the system is stopped while holding an execution state of software).

In S1, the contents (context) of all the components (CPU 10, main memory 13, each of the chip sets, etc.) constituting the system and a power source supplied to their components are held. However, supply of a clock to the CPU is stopped. Power consumption in S1 is the highest of the sleep states, but it can return to S0 at high speed.

In S2, a power source is not supplied to a system cache and the CPU 10. Therefore, power consumption required in S2 reduces as compared with power consumption required in S1.

In S3, a power source of the main memory (and some chip sets) is held. That is, the contents stored in the main memory (and some chip sets) are held. Power consumption required in S3 becomes lower as compared with power consumption required in S2.

In S4, the contents of the main memory, etc., are retained in a non-volatile storage such as a hard disk, and power source supply to the components other than the non-volatile storage is stopped. Power consumption in S4 is the lowest of the sleep states (equal to the state of S5), but of the sleep states, it takes the longest time period to return to S0. That is, S4 is the “deepest” sleep state of the sleep states.

Incidentally, before shifting from S0 to each of the sleep states, the contents stored in the system memory, etc., are retained and at the time of returning from S1-S4 to S0, the retained contents are restored, so that a continuous action of software can be performed after returning to S0.

A magnitude relation among power consumption of each of the system states and a magnitude relation among time periods of return from S1-S5 to S0 are as follows.

Power consumption: S0>S1>S2>S3>S4>S5

Return time period: S1<S2<S3<S4<S5

An on state ST1 shown in FIG. 4 is the S0 state in the ACPI specifications. That is, electric power is essentially supplied to most of the components constituting the system of the computer 1. Therefore, electric power is supplied to the communication part 123a and the signal detection part 123b constituting the wireless LAN device 24 and in principle, a function of the wireless LAN device 24 is turned on.

However, when the wireless communication switch 33 is set in an off state by a user in order to turn off the function of the wireless LAN device 24, electric power supply to the communication part 123a and the signal detection part 123b constituting the wireless LAN device 24 is stopped.

An off state ST3 is the S5 state in the ACPI specifications. That is, electric power supply to the components constituting the system of the computer 1 is stopped in principle.

However, when the wireless LAN service detection switch 34 is turned on, electric power is supplied to the signal detection part 123b as described above.

A suspend state ST2 is a state close to the S3 state and the S4 state in the ACPI specifications. The suspend state ST2 is a state in which electric power is supplied to the main memory 13 in order to hold the contents stored in the main memory 13, or a state in which electric power is supplied to a non-volatile storage after the contents of the main memory, etc., are retained in the non-volatile storage such as a hard disk.

In the suspend state ST2, electric power supply to the communication part 123a which is one of the components constituting the wireless LAN device 24 is stopped. When the wireless LAN service detection switch 34 is turned on, electric power is supplied to the signal detection part 123b as described above. Next, a system action of the computer 1 in the case that the computer 1 enters the inside of a wireless LAN service area from the outside of the wireless LAN service area will be described.

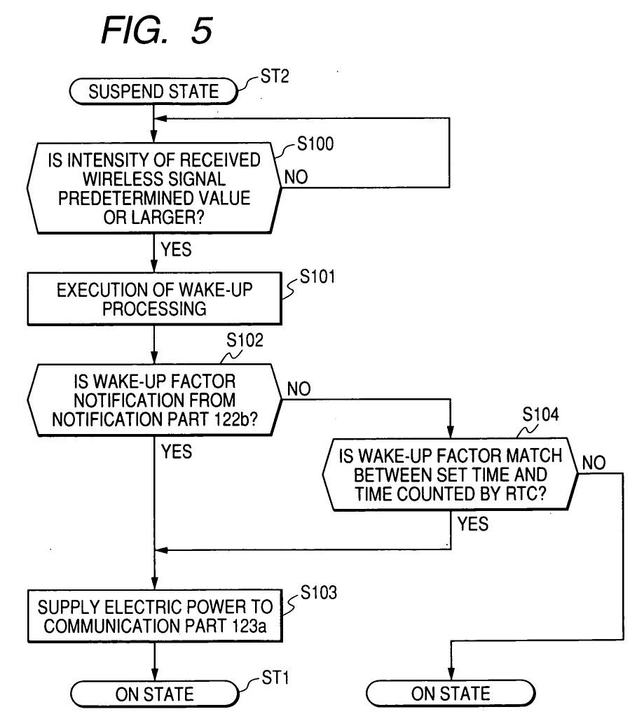

FIG. 5 is one example of an exemplary flowchart describing a system action of the computer 1 in the case that the computer 1 enters the inside of a wireless LAN service area from the outside of the wireless LAN service area.

A user carries the computer 1 in which a power source state is a state of the suspend state ST2. The wireless LAN service detection switch 34 disposed in the computer 1 is in a state of being turned on. That is, electric power is supplied to the signal detection part 123b and the EC/KBC 28.

The computer 1 receives a wireless signal sent out of a wireless LAN access point installed inside a wireless LAN service area, and the notification part 122b receives a digital signal converted by the ADC 122a. The notification part 122b evaluates the received digital signal and when intensity of the digital signal is a predetermined threshold value or larger, a PME signal is sent out to the PSC 30 (step S100 Yes).

When the PSC 30 receives the PME signal sent out of the notification part 122b, the PSC 30 supplies electric power to the CPU 10, the host hub 11, the I/O hub 20, the main memory 13, etc., among a group of components constituting the computer 1. When a power source state of the computer 1 is a hibernation state in the suspend state, electric power is also supplied to the HDD 21.

Therefore, the power source state of the computer 1 starts to shift from the suspend state ST2 to the on state ST1 (step S101).

When the power source state of the computer 1 starts to shift to the on state ST1, the System BIOS 13a determines a system wake-up factor. When the System BIOS 13a determines that the system wake-up factor is notification from the notification part 122b (step S102 Yes), the PSC 30 supplies electric power to the communication part 123a through the PCI interface 100 (step S103).

When the System BIOS 13a does not determine that the system wake-up factor is notification from the notification part 122b (step S102 No), the System BIOS 13a determines whether or not the system wake-up factor is a match between set time and time counted by the RTC 29a (step S104). When the System BIOS 13a determines that the system wake-up factor is the match between set time and time counted by the RTC 29a (step S104 Yes), the PSC 30 supplies electric power to the communication part 123a through the PCI interface 100 (step S103). The wake-up by match between set time and time counted by the RTC 29a will be described later. The power source state of the computer 1 becomes the on state ST1 when electric power is supplied to the communication part 123a.

When the System BIOS 13a does not determine that the system wake-up factor is the match between set time and time counted by the RTC 29a (step S104 No), the power source state of the computer 1 becomes the on state. Next, a system action after the power source state of the computer 1 shifts to the on state ST1 will be described.

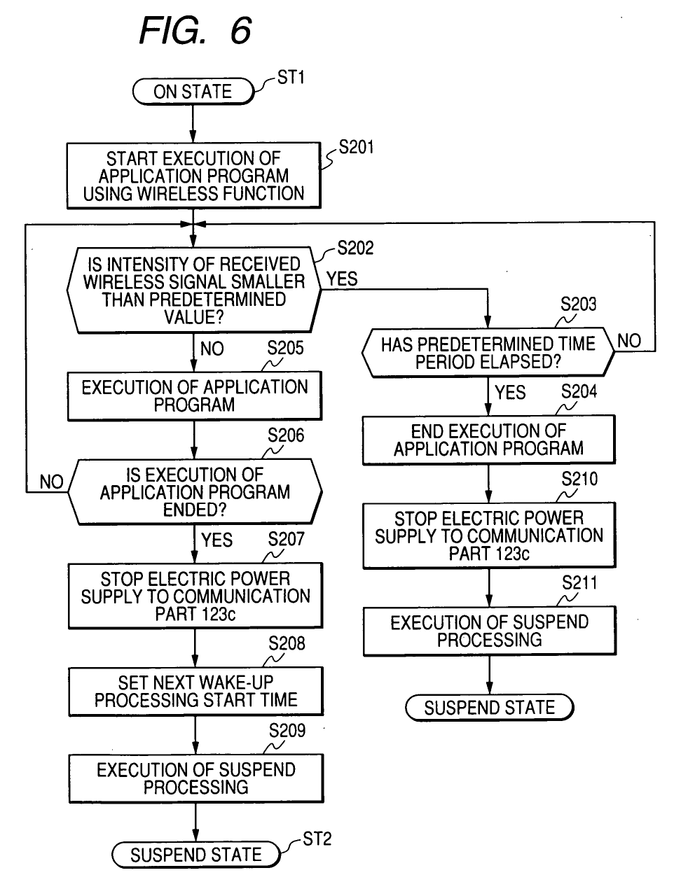

FIG. 6 is one example of an exemplary flowchart describing a system action after the power source state of the computer 1 shifts from the suspend state ST2 to the on state ST1.

In a state in which the power source state of the computer 1 becomes the on state ST1 and electric power is supplied to the communication part 123a, execution of an application using a wireless function is started (step S201). As one example of the application using the wireless function, for example, a mail application, an application for downloading data from a predetermined server on the Internet or uploading data to a predetermined server, etc., are given.

Even during execution of an application program, electric field intensity of a wireless signal received by the wireless LAN device 24 is evaluated by the notification part 122b. When the notification part 122b determines that intensity of a digital signal is a predetermined threshold value or larger during execution of the application program (step S202 No), the execution of the application program is continued without being ended (step S205).

When the OS 13b determines that the execution of the application program is ended (step S206 Yes), the OS 13b notifies the wireless LAN driver 401 to stop electric power supply to the communication part 123a. When the OS 13b does not determine that the execution of the application program is ended (step S206 No), the flowchart returns to the processing of step S202.

The execution of the application program is ended, for example, after the application program ends predetermined processing using a wireless function. For example, after the application program ends predetermined processing such as sending and receiving of mail preset by a user, the execution of the application program is ended. The wireless LAN driver 401 stops electric power supply to the communication part 123a by sending out a command to the electric power control circuit 123c based on the notification from the OS 13b (step S207).

The OS 13b notifies the System BIOS 13a that the execution of the application program is ended. When the System BIOS 13a receives this notification, time at which system wake-up processing is again started is set (step S208). This set time data is stored in, for example, the CMOS 29.

The time at which the system wake-up processing is again started is set as described below. For example, time (called “time of ending suspend processing”) at which a shift to a suspend state again is made from an on state shifted from a suspend state by entering the inside of a wireless LAN service area of the computer 1 and performing wake-up processing is stored in, for example, the CMOS 29 by the System BIOS 13a.

Also, a user of the computer 1 presets a time period (called “a time period necessary to start wake-up again”) ranging from time at which the computer 1 shifts from an on state to a suspend state after wake-up to the on state inside a wireless LAN service area to start time of wake-up processing from a suspend state to an on state again. The user sets this time period, for example, through a setting screen of BIOS before an OS of the computer 1 is activated. This set time period is stored in, for example, the CMOS 29.

The System BIOS 13a calculates the time set in step S208, for example, by adding “the time period necessary to start wake-up again” to “the time of ending suspend processing”.

When the System BIOS 13a sets the time at which the system wake-up processing is again started, suspend processing is started (step S209). After the suspend processing by the System BIOS 13a, the power source state of the computer 1 shifts from the on state ST1 to the suspend state ST2.

On the other hand, when the notification part 122b does not determine that the intensity of the digital signal is the predetermined threshold value or larger during execution of the application program, that is, determines that the intensity of the digital signal is smaller than the threshold value (step S202 Yes) and a predetermined time period has elapsed (step S203 Yes), the System BIOS 13a recognizes that the intensity of the digital signal is smaller than the predetermined threshold value. When the notification part 122b determines that the intensity of the digital signal is smaller than the predetermined threshold value during execution of the application program (step S202 Yes) and the predetermined time period has not elapsed (step S203 No), the processing of step S202 is performed continuously.

When the System BIOS 13a recognizes that the electric field intensity of the received wireless signal is smaller than the predetermined threshold value, the System BIOS 13a notifies the OS 13b to end the execution of the application program. When the OS 13b receives the notification of the end of the execution of the application program, the execution of the application program is ended (step S204).

When the OS 13b receives the notification of the end of the execution of the application program, the OS 13b further notifies the wireless LAN driver 401 to stop electric power supply to the communication part 123a. The wireless LAN driver 401 stops electric power supply to the communication part 123a by sending out a command to the electric power control circuit 123c based on the notification from the OS 13b (step S210).

The OS 13b notifies the System BIOS 13a that the execution of the application program is ended. The System BIOS 13a starts suspend processing (step S211). After the suspend processing by the System BIOS 13a, the power source state of the computer 1 shifts from the on state ST1 to the suspend state ST2.

The processing for the System BIOS 13a to recognize that the intensity of the digital signal is smaller than the predetermined threshold value by the processing of step S202 Yes and step S203 Yes, and the processing of step S204, step S210 and step S211 are processing performed in the case that the computer 1 exits from the inside of a wireless LAN service area to the outside of the service area. Next, a system action after the power source state of the computer 1 shifts to the suspend state ST2 after the processing of step S209 will be described.

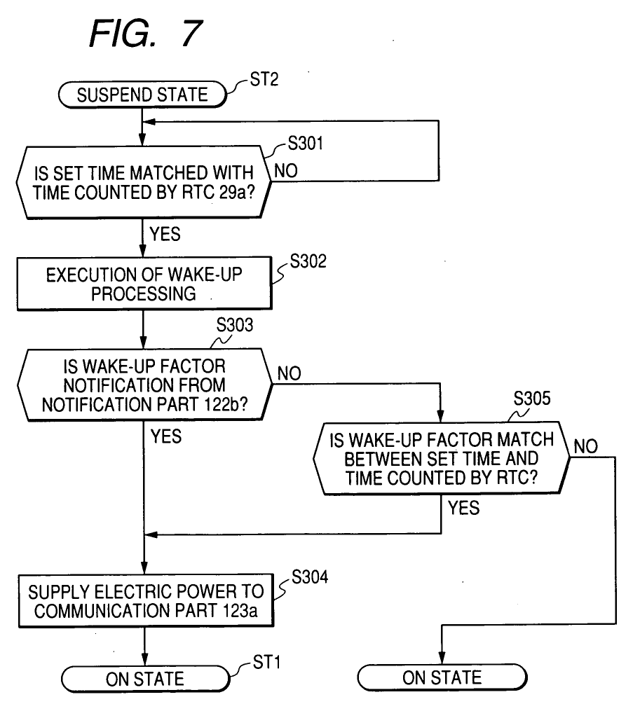

FIG. 7 is one example of an exemplary flowchart describing a system action after the power source state of the computer 1 shifts to the suspend state ST2.

After the power source state of the computer 1 shifts to the suspend state ST2 after the processing of step S209, the System BIOS 13a determines whether or not the time set in step S208 is matched with time counted by the RTC (step S301). When the System BIOS 13a determines that the time set in step S208 is matched with the time counted by the RTC (step S301 Yes), the System BIOS 13a performs system wake-up processing. The System BIOS 13a notifies the EC/KBC 28 that the system wake-up processing is performed. The EC/KBC 28 notifies the PSC 30 to supply electric power to a group of components constituting the computer 1.

When the PSC 30 receives notification from the EC/KBC 28, the PSC 30 supplies electric power to the CPU 10, the host hub 11, the I/O hub 20, the main memory 13, etc., among a group of components constituting the computer 1. When the power source state of the computer 1 is a hibernation state, electric power is also supplied to the HDD 21 (step S302).

The power source state of the computer 1 starts to shift from the suspend state ST2 to the on state ST1. When the power source state of the computer 1 starts to shift to the on state ST1, the System BIOS 13a determines a system wake-up factor. When the System BIOS 13a determines that the system wake-up factor is notification from the notification part 122b (step S303 Yes), the PSC 30 supplies electric power to the communication part 123a through the PCI interface 100 (step S304).

When the System BIOS 13a does not determine that the system wake-up factor is notification from the notification part 122b (step S303 No), the System BIOS 13a determines whether or not the system wake-up factor is a factor in a match between set time and time counted by the RTC 29a (step S305). When the System BIOS 13a determines that the system wake-up factor is the factor in the match between set time and time counted by the RTC 29a (step S305 Yes), the PSC 30 supplies electric power to the communication part 123a through the PCI interface 100 (step S304). The power source state of the computer 1 becomes the on state ST1 when electric power is supplied to the communication part 123a. After the power source state of the computer 1 becomes the on state ST1, the system of the computer 1 executes the action described by using the flowchart of FIG. 7.

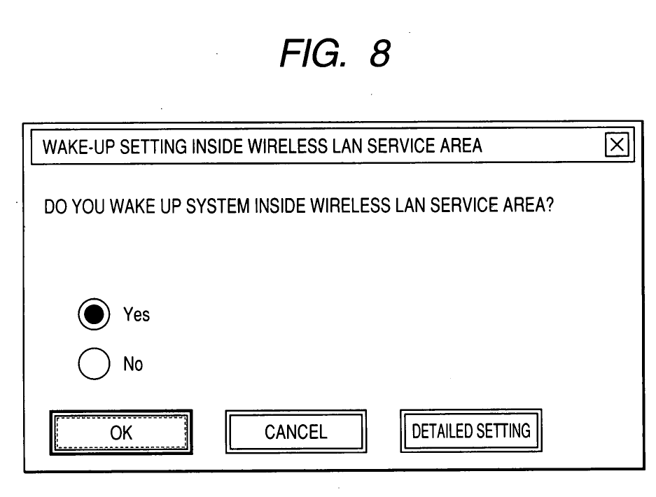

A wake-up function from the suspend state ST2 to the on state ST1 in the case that the computer 1 with the wireless LAN service detection switch 34 turned on enters the inside of a wireless LAN service area from the outside of the wireless LAN service area as described by using FIG. 5 is set in an enabled state or a disabled state by displaying a window shown in FIG. 8 on the LCD 4 with the power source state of the computer 1 turned on and using this window. Next, a modified example of control of electric power supply to the wireless LAN device 24 described by using FIG. 3 will be described.

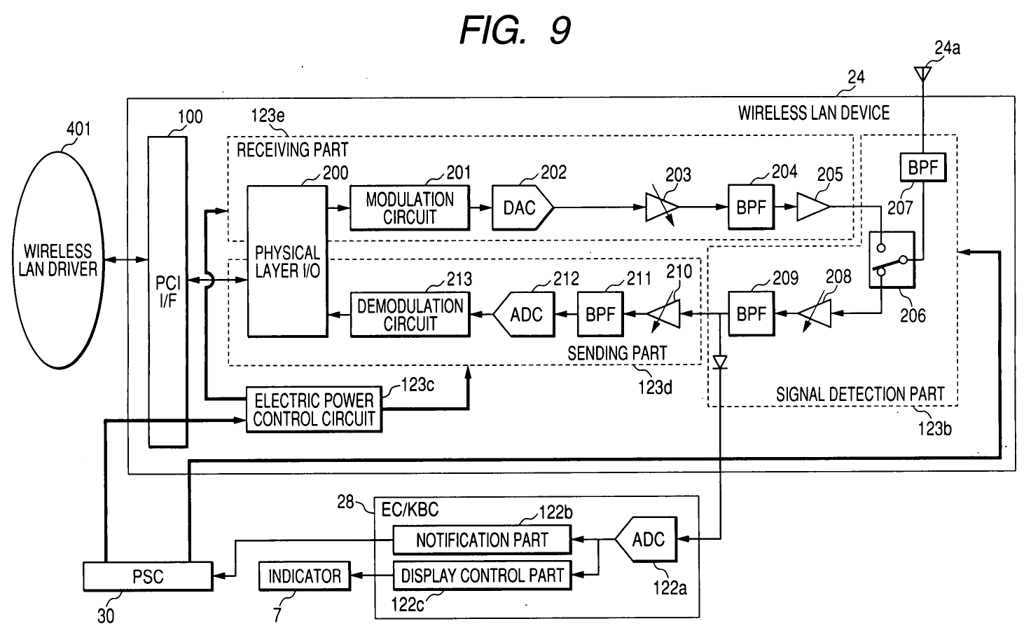

FIG. 9 is an exemplary diagram showing a modified example of control of electric power supply to the wireless LAN device 24 described by using FIG. 3.

A configuration shown in FIG. 9 differs from the configuration shown in FIG. 3 in that electric power supplied to the communication part 123a in FIG. 3 is separately supplied to a sending part 123d and a receiving part 123e in FIG. 9.

That is, in control of electric power supply to a wireless LAN device 24 shown in FIG. 9, control in which electric power supplied from a PSC 30 to an electric power control circuit 123c through a PCI interface 100 by a command sent from a wireless LAN driver 401 to the electric power control circuit 123c is supplied to the sending part 123d and the receiving part 123e, is supplied to only the sending part 123d or is supplied to only the receiving part 123e is performed.

By performing such electric power supply control, the following electric power control can be performed after waking up from a suspend state ST2 to an on state ST1 in the case that a computer 1 with a wireless LAN service detection switch 34 turned on enters the inside of a wireless LAN service area from the outside of the wireless LAN service area.

When an application program only receives data sent from an access point disposed inside a wireless LAN service area in the case that the computer 1 shifting to the on state ST1 executes the application program using a wireless function inside the wireless LAN service area, electric power could be supplied to only the receiving part 123e by controlling the electric power control circuit 123c. In this case, electric power savings can be achieved by the amount of electric power supplied to the sending part 123d.

Also, when data is only sent from an application program to an access point disposed inside a wireless LAN service area in the case that the computer 1 shifting to the on state ST1 executes the application program using a wireless function inside the wireless LAN service area, electric power could be supplied to only the sending part 123d by controlling the electric power control circuit 123c. In this case, electric power savings can be achieved by the amount of electric power supplied to the receiving part 123e.

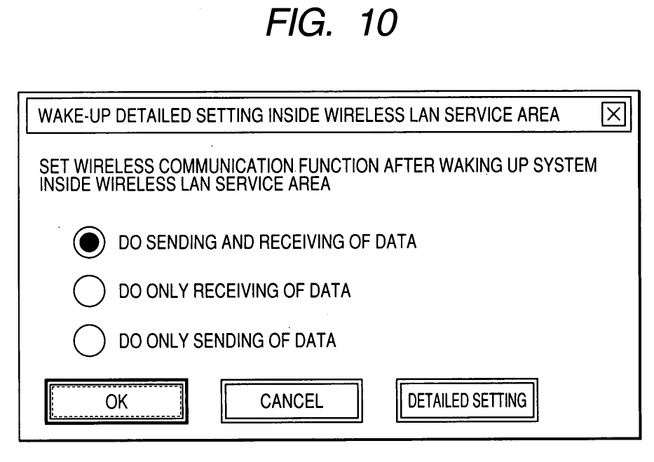

A function of separately supplying electric power to, for example, the sending part 123d and the receiving part 123e inside the wireless LAN device 24 after waking up from the suspend state ST2 to the on state ST1 in the case that the computer 1 with the wireless LAN service detection switch 34 turned on enters the inside of a wireless LAN service area from the outside of the wireless LAN service area as described by using FIG. 9 is set by displaying a window shown in FIG. 10 on an LCD 4 with a power source state of the computer 1 turned on and using this window. The window shown in FIG. 10 is a GUI which the power-saving utility 13c described in FIG. 2 has. Next, a second embodiment will be described.

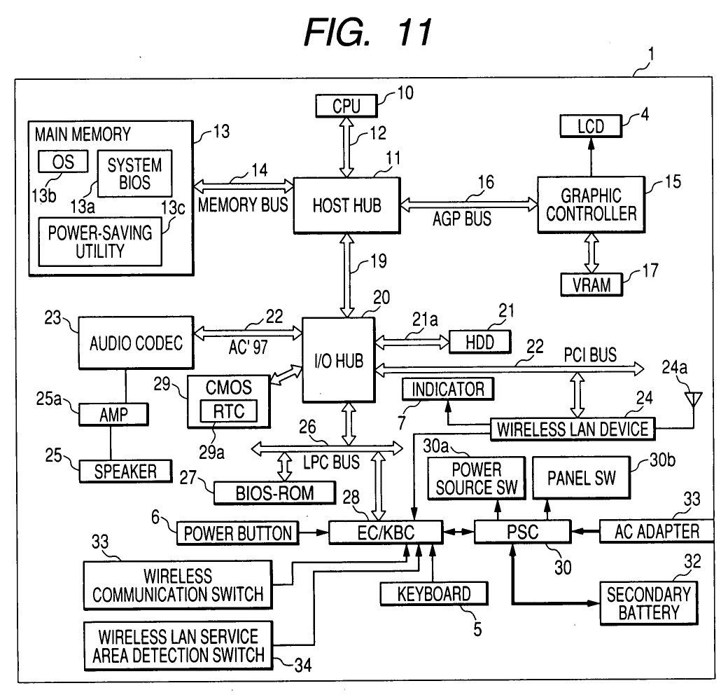

FIG. 11 is an exemplary diagram showing one example of a hardware configuration of a computer 1 in the second embodiment.

A configuration shown in FIG. 11 differs from the configuration shown in FIG. 2 in that the indicator 7 in FIG. 2 is connected to a wireless LAN device 24 rather than an EC/KBC 28. Next, a hardware configuration example of the wireless LAN device 24 in the second embodiment will be described.

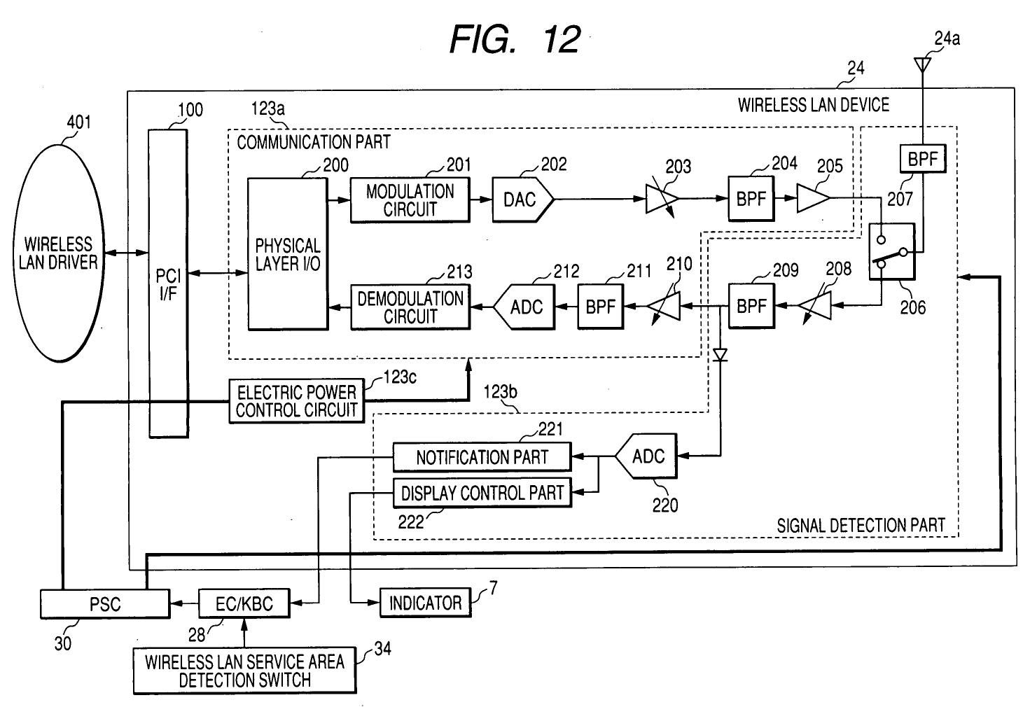

FIG. 12 is an exemplary diagram describing one example of control of electric power supply to the wireless LAN device 24 and a configuration of the wireless LAN device 24 in the second embodiment.

A configuration shown in FIG. 12 differs from the configuration shown in FIG. 3 in that the ADC 122a, the notification part 122b and the display control part 122c in FIG. 3 are not disposed inside the EC/KBC 28 and an ADC 220, a notification part 221 and a display control part 222 are disposed inside a signal detection part 123b of the inside of the wireless LAN device 24 and the notification part 221 is connected to an EC/KBC 28.

The notification part 221 evaluates a signal level of a digital signal converted by the ADC 220. The notification part 221 sends out a predetermined signal to the EC/KBC 28 according to a signal level corresponding to intensity of a received wireless signal. When the EC/KBC 28 receives the predetermined signal sent out of the notification part 221, a PME (Power Management Event) signal is sent out to a PSC 30. After the PSC 30 receives the PME signal sent out of the EC/KBC 28, processing described by using FIG. 3, FIGS. 5 to 7 is performed. Next, a modified example of control of electric power supply to the wireless LAN device 24 described by using FIG. 12 will be described.

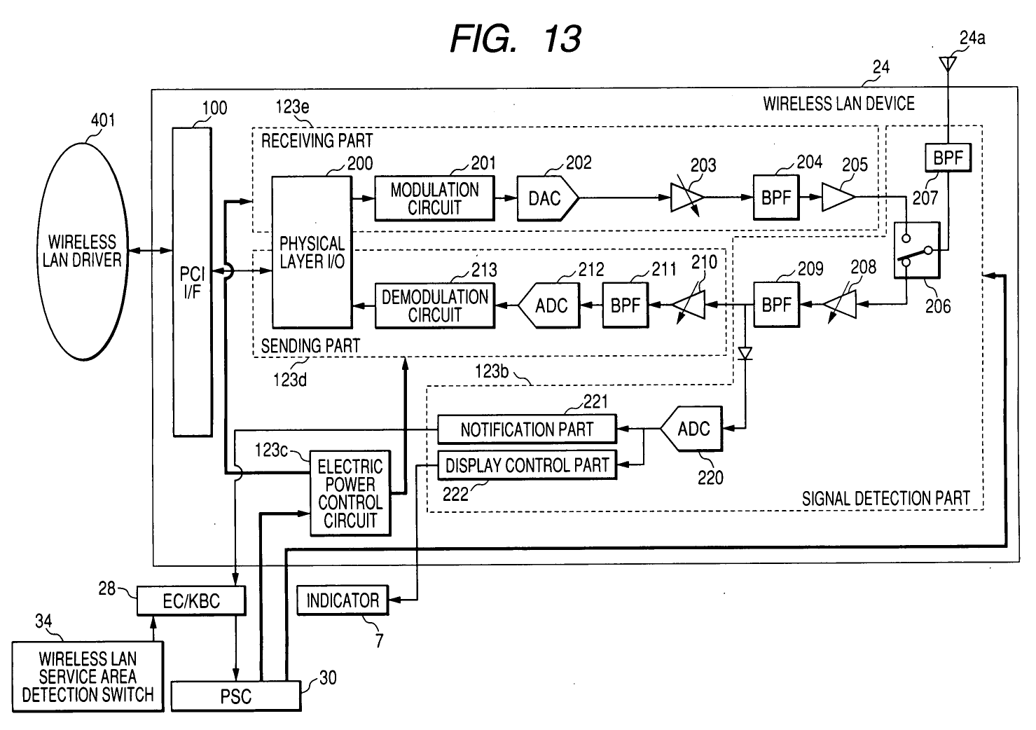

FIG. 13 is an exemplary diagram showing a modified example of control of electric power supply to the wireless LAN device 24 described by using FIG. 12.

A configuration shown in FIG. 13 differs from the configuration shown in FIG. 12 in that electric power supplied to the communication part 123a in FIG. 12 is separately supplied to a sending part 123d and a receiving part 123e in FIG. 13. Incidentally, an idea of electric power supply control described by using FIG. 13 is based on the idea of electric power control method described by using FIG. 9, so that further description refers to the description using FIG. 9.

As described above, in the present embodiment, by previously supplying electric power to a signal detection part, the computer 1 which is an information processing apparatus according to the invention can detect intensity of a wireless signal sent out of an access point of the inside of a wireless LAN service area, and can decide the inside or the outside of the wireless LAN service area according to the intensity of the wireless signal.

Also, in the case of deciding that the computer 1 is present inside the wireless LAN service area, a power source state of the computer 1 is returned from a suspend state to a power-on state and also a power source is supplied to the communication part 123a of the inside of the wireless LAN device 24 which the computer 1 has, so that wireless communication with the access point of the inside of the wireless LAN service area can be conducted.

Further, a power source of the communication part 123a of the inside of the wireless LAN device 24 is not turned on until the computer 1 enters the inside of the wireless LAN service area, so that the amount of electric power to be supplied to the communication part 123a is not consumed in the outside of the wireless LAN service area and electric power savings can be achieved.

Also, in the embodiment, it has been configured so that electric power is supplied to some components constituting the wireless LAN device in order to detect electric field intensity of a wireless signal when a power source state of the computer 1 is a suspend state, but it may be configured so that a detection part for detecting electric field intensity of a wireless signal is disposed separately from a wireless LAN device and electric power is supplied to the detection part disposed separately from the wireless LAN device in a suspend state and the electric field intensity of the wireless signal is detected.

Also, in the embodiment, the configuration in which a power source state of the computer 1 wakes up from a suspend state to an on state when the computer 1 enters the inside of a wireless LAN service area has been described. However, it may be configured so that a power source state of the computer 1 is activated (booted) from an off state to an on state when the computer 1 in the off state enters the inside of a wireless LAN service area by being configured to supply electric power to a detection part for detecting a wireless signal at the time when a power source state of the computer 1 is an off state. Further, it may be configured to activate a predetermined application program after a power source state of the computer 1 is booted from an off state to an on state by entering a wireless LAN service area.

Also, in the embodiment, the configuration of displaying status information corresponding to intensity (electric field intensity) of a wireless signal in the indicator 7 has been described. However, it may be configured to display an execution state of a predetermined application program executed after the computer 1 wakes up from a suspend state to an on state inside a wireless LAN service area in the indicator 7. In this case, when the application program is an application program, for example, having a mail sending and receiving function, a use method of the indicator 7, for example, displaying a state of arrival, etc., of new mail in the indicator 7 is contemplated. Further, a use method of the indicator 7, for example, displaying whether or not a wireless LAN service area is the wireless LAN service area provided by a specific contract provider in the indicator 7 is contemplated.

Also, the invention is not limited to the as-is embodiment described above and at the execution stage, components can be modified and embodied without departing from the gist. Also, various inventions can be formed by proper combinations of plural components disclosed in the embodiment. For example, some components may be deleted from all the components shown in the embodiment. Further, components in the different embodiment may be combined properly.

The invention is not limited to the foregoing embodiments but various changes and modifications of its components may be made without departing from the scope of the present invention. Also, the components disclosed in the embodiments may be assembled in any combination for embodying the present invention. For example, some of the components may be omitted from all the components disclosed in the embodiments. Further, components in different embodiments may be appropriately combined.

What is claimed is:

1. An information processing apparatus capable of performing wireless communication with an external device, comprising:
a wireless communication part which performs the wireless communication using a wireless signal of a predetermined frequency band;
a detection part which detects intensity of the wireless signal; and
a power source control part which supplies a power source to the detection part in a first state of the information processing apparatus, the power source control part, when a value of intensity of the wireless signal detected by the detection part is larger than a predetermined threshold value, which shifts a state of information processing apparatus from the first state to a second state in which the power source is supplied to at least the detection part and the wireless communication part.

2. The information processing apparatus according to claim 1, further comprising
a switch which turns on and off a wireless signal intensity detection function of the detection part,
wherein when the switch is turned on, the power source control part supplies the power source to the detection part in the first state.

3. The information processing apparatus according to claim 1, further comprising
a display part which displays a level of the wireless signal according to the intensity of the wireless signal,
wherein the display part displays the level of the wireless signal according to intensity of the wireless signal detected by the detection part in the first state.

4. The information processing apparatus according to claim 1, further comprising
an application program which uses the wireless communication performed by the wireless communication part,
wherein the application program executes a predetermined processing after the power source control part shifts the state of the information processing apparatus from the first state to the second state, and the power source control part shifts the state of the information processing apparatus from the second state to the first state after the application program executes the predetermined processing.

5. The information processing apparatus according to claim 1, further comprising
a setting part, after the state of the information apparatus is shifted to the second state, which sets a wake-up processing start time at which wake-up processing from the first state to the second state is started,
wherein the power source control part shifts the state of the information apparatus from the first state to the second state according to the set wake-up processing start time.

6. The information processing apparatus according to claim 1, wherein the power source control part, when the detection part detects intensity of a wireless signal with a value smaller than a predetermined threshold value over a predetermined period after the power source control part shifts the state of information processing apparatus to the second state, shifts the state of the information processing apparatus from the second state to the first state.

7. The information processing apparatus according to claim 1, wherein the wireless communication part includes a sending part and a receiving part, and the information processing apparatus further comprises a driver which individually controls power source supply to the sending part and the receiving part.

8. A power source control method performed by an information processing apparatus having a wireless communication part which performs wireless communication with an external device using a wireless signal of a predetermined frequency band and a detection part which detects intensity of the wireless signal, the method comprising:
supplying a power source to the detection part in a first state of the information processing apparatus;
detecting a value of intensity of the wireless signal by the detection part; and
when the value of intensity of the wireless signal detected by the detection part is larger than a predetermined threshold value, shifting a state of the information processing apparatus from the first state to a second state in which the power source is supplied to at least the detection part and the wireless communication part.

9. The power source control method according to claim 8, further comprising:
turning on a switch which turns on and off a wireless signal intensity detection function of the detection part,
wherein when the switch is turned on, the power source is supplied to the detection part in the first state.

10. The power source control method according to claim 8, further comprising:
executing predetermined processing by application program which uses the wireless communication performed by the wireless communication part after the power source is supplied to the wireless communication part; and
stopping power source supply to the wireless communication part to shift the state of the information processing apparatus from the second state to the first state after the application program executes the predetermined processing.

11. The power source control method according to claim 8, further comprising:
after the state of the information apparatus is shifted to the second state, setting a wake-up processing start time at which wake-up processing from the first state to the second state is started; and
shifting the state of the information apparatus from the first state to the second state according to the set wake-up processing start time.

12. The power source control method as claimed in claim 8, further comprising
when the detection part detects intensity of a wireless signal with a value smaller than a predetermined threshold value over a predetermined period after the power source control part shifts the state of information processing apparatus to the second state, shifting the state of the information processing apparatus from the second state to the first state.

13. The power source control method as claimed in claim 8, further comprising
controlling power source supply to a sending part and a receiving part included in the wireless communication part individually by a driver.
